(19) United States
(12) Patent Application Publication
(10) Pub. No.: US 2026/0300764 A1
(43) Pub. Date: Oct. 1, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventors: Ryosuke HOTCHI, Tokyo (JP); Masaharu MORIMOTO, Tokyo (JP); Masaki INOKUCHI, Tokyo (JP); Shunsuke OSAKI, Tokyo (JP); Tatsuya FUKUDA, Tokyo (JP); Yoshiaki SAKAE, Tokyo (JP); Joe BRINTON, Tokyo (JP); Sian En OOI, Tokyo (JP)

(73) Assignee: NEC Corporation, Tokyo (JP)

(21) Appl. No.: 19/434,375

(22) Filed: Dec. 29, 2025

(30) Foreign Application Priority Data
Mar. 26, 2025 (JP) 2025-052244

(51) Int. Cl. G06N 5/022

(52) U.S. Cl. CPC G06N 5/022

(57) ABSTRACT

An information processing device includes at least one memory storing instructions and at least one processor configured to execute the instructions to receive input data to a generation model, extract reference information from among a plurality of pieces of reference information based on a label indicating an attribute of each piece of reference information, and cause the generation model to refer to the extracted reference information and generate output data. The generated output data can also be used for user’s decision making.

### INCORPORATION BY REFERENCE

This application is based upon and claims the benefit of priority from Japanese patent application No. 2025-052244, filed on Mar. 26, 2025, the disclosure of which is incorporated herein in its entirety by reference.

### TECHNICAL FIELD

The present disclosure relates to an information processing device, an information processing method, and a non-transitory computer-readable medium.

### BACKGROUND ART

A technique for performing natural language processing such as questions and answers using a Large Language Model (LLM) is known. A related art related to LLM includes, for example, that described in JP 7441366 B2. JP 7441366 B2 describes an information processing device that selects a database associated with an input question among a plurality of databases storing different types of data based on the content of the question, generates a prompt for inputting into a language model based on the selected database and the question, and generates an answer based on the generated prompt and the language model. Since the information processing device described in JP 7441366 B2 generates an answer based on a database selected based on the content of the question, it is possible to generate an answer with improved accuracy.

### SUMMARY

However, the information processing device described in JP 7441366 B2 can only reflect the data recorded in the database in the answer, and cannot adjust the criterion for generating the answer, and thus there is room for further improvement in terms of improving the accuracy of the answer. For example, it is assumed that a question “Does the content of sentence XXX satisfy the condition of YYY?” is input to the LLM. In this case, if the LLM determination criterion as to whether the above condition is satisfied is deviated from the sense of the interrogator, it is considered that there is a high possibility that an answer that the interrogator feels uncomfortable is generated even if the LLM is caused to refer to the data recorded in the database.

In addition, the fact that there is room for improvement in terms of higher accuracy is not limited to the case of causing the LLM to generate an answer to a question, and is common to the case of causing any generation model to generate any output data. An example object of the present disclosure is to provide a technique capable of improving accuracy of output data generated by a generation model.

An information processing device according to an example aspect of the present disclosure includes at least one memory storing instructions, and at least one processor configured to execute the instructions to receive an input of target data as input data to a generation model subjected to machine learning to generate output data associated with input data, extract reference information from a plurality of pieces of reference information the generation model can be caused to refer to, based on a label that indicates an attribute of each piece of reference information associated in advance with each of the plurality of pieces of reference information, and cause the generation model to refer to the extracted reference information and generate output data associated with the reference information and the target data.

In an information processing method according to an example aspect of the present disclosure, at least one processor executes reception processing of receiving an input of target data as input data to a generation model subjected to machine learning to generate output data associated with input data, extraction processing of extracting reference information from a plurality of pieces of reference information the generation model can be caused to refer to, based on a label that indicates an attribute of each piece of reference information associated in advance with each of the plurality of pieces of reference information, and generation control processing of causing the generation model to refer to the reference information extracted in the extraction processing and generate output data associated with the reference information and the target data.

A non-transitory computer-readable medium storing an information processing program according to an example aspect of the present disclosure executes reception processing of receiving an input of target data as input data to a generation model subjected to machine learning to generate output data associated with input data, extraction processing of extracting reference information from a plurality of pieces of reference information the generation model can be caused to refer to, based on a label that indicates an attribute of each piece of reference information associated in advance with each of the plurality of pieces of reference information, and generation control processing of causing the generation model to refer to the reference information extracted in the extraction processing and generate output data associated with the reference information and the target data.

According to an example aspect of the present disclosure, there is an exemplary effect that the accuracy of the output data generated by the generation model can be improved.

### BRIEF DESCRIPTION OF DRAWINGS

The above and other aspects, features, and advantages of the present disclosure will become more apparent from the following description of certain example embodiments in a case where taken in conjunction with the accompanying drawings, in which:

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of another information processing device according to the present disclosure;

FIG. 4 is a diagram illustrating an execution example of a determination task by the information processing device illustrated in FIG. 3;

FIG. 5 is a diagram illustrating an example of various types of data used for a determination task;

FIG. 6 is a diagram illustrating a display screen example displayed at the time of execution of a determination task by the information processing device illustrated in FIG. 3;

FIG. 7 is a flowchart illustrating a flow of processing executed by the information processing device illustrated in FIG. 3; and

FIG. 8 is a block diagram illustrating a configuration of a computer functioning as the information processing device according to the present disclosure.

### EXAMPLE EMBODIMENT

Hereinafter, example embodiments of the present disclosure will be exemplified. However, the present disclosure is not limited to each of the exemplary example embodiments described below, and various modifications can be made within a scope described in the claims. For example, example embodiments obtained by appropriately combining techniques (some or all of things or methods) adopted in each of the exemplary example embodiments described below can also be included in the scope of the present disclosure. Example embodiments obtained by appropriately omitting some of the techniques adopted in each of the exemplary example embodiments described below can also be included in the scope of the present disclosure. Effects mentioned in each of the exemplary example embodiments described below are examples of effects expected in the exemplary example embodiments, and do not define extension of the present disclosure. That is, example embodiments that do not provide the effects mentioned in each of the exemplary example embodiments described below can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment can also be adopted in another exemplary example embodiment included in the present disclosure within a range in which no particular technical problem occurs.

### Configuration of Information Processing Device 1

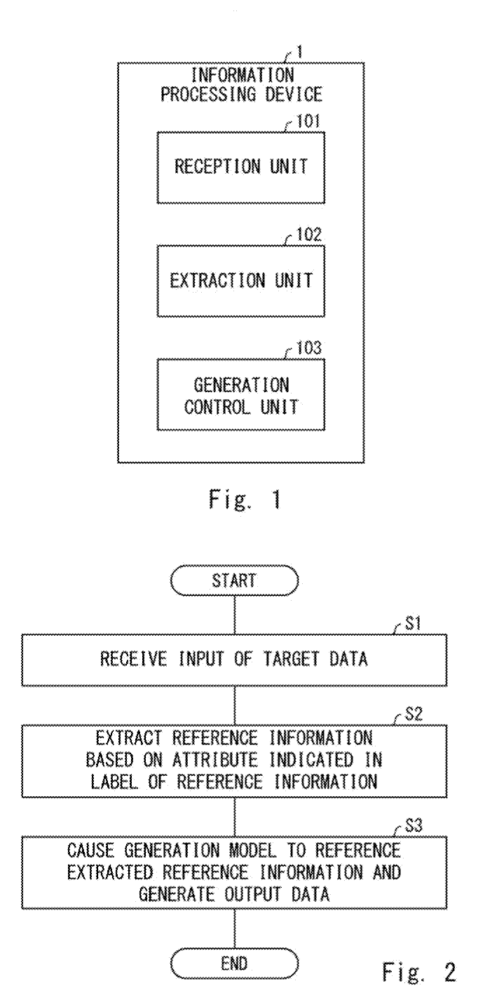

A configuration of an information processing device 1 according to the present exemplary example embodiment will be described with reference to FIG. 1. FIG. 1 is a block diagram illustrating a configuration of the information processing device 1. As illustrated in FIG. 1, the information processing device 1 includes a reception unit 101, an extraction unit 102, and a generation control unit 103.

The reception unit 101 receives an input of target data as input data for a generation model subjected to machine learning to generate output data associated with the input data. Here, the “input data” means data input to cause the generation model to generate output data, and is data from which the output data is generated.

The reception unit 101 receives target data in a format associated with the generation model. For example, in a case where a generation model to which text data described in a natural language can be input is used, the reception unit 101 receives an input of target data in a text format described in a natural language. Furthermore, for example, in a case where a generation model to which image data can be input, such as a generation model that generates text data describing the content of the input image, the reception unit 101 may receive the input of the image data.

The “generation model” is a learned model subjected to machine learning to output output data associated with input data. The above generation model can also be referred to as generation Artificial Intelligence (AI) or the like. The output data generated by the above generation model is any data. For example, the generation model may generate at least one of text data, image data (may be still image data or moving image data.), and voice data.

The extraction unit 102 extracts reference information based on a label that indicates an attribute of each piece of reference information associated in advance with each of the plurality of pieces of reference information from among a plurality of pieces of reference information the generation model can be caused to refer to.

The “reference information” may be any information the generation model can be caused to refer to. Here, “to cause to refer to” means to input the reference information to the generation model in some form. For example, the generation model may refer to the reference information by incorporating the reference information into a prompt for instructing to generate the output data and inputting the reference information into the generation model. The “reference information” can also be rephrased as “additional input information” to the generation model. The prompt indicates an instruction for the generation model. By inputting a prompt to the generation model, output data associated with an instruction indicated in the prompt is output from the generation model.

Furthermore, the “label” may indicate an attribute of the reference information. The “label” can also be referred to as “meta information”, “tag”, or the like. For example, the “label” may be a keyword or the like indicating an attribute of the reference information. The “label” may indicate one attribute or a plurality of attributes. In addition, a plurality of “labels” indicating one attribute may be associated with one piece of reference information.

Furthermore, extracting the reference information “based on” the label indicating the attribute of the reference information means directly or indirectly using the attribute indicated in the label in extracting the reference information. For example, the extraction unit 102 may extract the reference information by using the attribute indicated in the label as it is, or may extract the reference information by using an analysis result obtained by analyzing the attribute indicated in the label.

Here, the “attribute” of the reference information means a characteristic, a property, or a feature of the reference information. Therefore, the “attribute” of the reference information can also be rephrased as a “characteristic”, a “property”, a “feature”, or the like of the reference information. Furthermore, the “attribute” of the reference information can also be rephrased as a “profile” of the reference information.

The generation control unit 103 causes the generation model to refer to the reference information extracted by the extraction unit 102 and generate output data associated with the reference information and the target data. As described above, “to cause to refer” means that the reference information is input to the generation model in some form. By causing the reference information to be referred to, the generation model can be caused to generate output data associated with the reference information.

As described above, the information processing device 1 according to the present exemplary example embodiment adopts a configuration including the reception unit 101 for receiving an input of target data as input data to a generation model subjected to machine learning to generate output data associated with the input data, the extraction unit 102 for extracting, from among a plurality of pieces of reference information the generation model can be caused to refer to, reference information based on a label that indicates an attribute of each piece of reference information associated in advance with each of the plurality of pieces of reference information, and the generation control unit 103 for causing the generation model to refer to the reference information extracted by the extraction unit 102 and generate output data associated with the reference information and the target data.

According to the above configuration, the reference information is extracted based on the attribute indicated in the label associated in advance with each of the plurality of pieces of reference information, and the generation model references the extracted reference information to generate the output data. As a result, it is possible to reflect the reference information of the valid attribute in the output data. Therefore, according to the information processing device 1, an effect is obtained that the accuracy of the output data generated by the generation model can be improved.

Furthermore, the output data generated by the information processing device 1 can also be used for decision making by the user of the information processing device 1. For example, the user can input target data indicating a matter for which the user is to make a final determination to the information processing device 1, and can cause a determination result regarding the matter to be generated by using a determination case of an attribute related to the matter as reference information. In this case, a label indicating the attribute may be given in advance to each determination case. As a result, a valid determination result based on a determination case related to the attribute is obtained, and the user can make a final determination with reference to the determination result.

### Information Processing Program

The functions of the information processing device 1 described above can also be achieved by a program. An information processing program according to the present exemplary example embodiment causes a computer to function as a reception means for receiving an input of target data as input data to a generation model subjected to machine learning to generate output data associated with the input data, the extraction means for extracting, from among a plurality of pieces of reference information the generation model can be caused to refer to, reference information based on a label that indicates an attribute of each piece of reference information associated in advance with each of the plurality of pieces of reference information, and the generation control means for causing the generation model to refer to the reference information extracted by the extraction means and generate output data associated with the reference information and the target data. According to this information processing program, an effect is obtained that the accuracy of the output data generated by the generation model can be improved.

### Flow of Information Processing Method

Next, a flow of an information processing method according to the present exemplary example embodiment will be described with reference to FIG. 2. FIG. 2 is a flowchart illustrating a flow of an information processing method. An executing entity of each step in this information processing method may be a processor included in the information processing device 1, may be a processor included in another device, or an executing entity of each step may be a processor provided in each of different devices.

In S1 (reception processing), at least one processor receives an input of target data as input data for a generation model subjected to machine learning to generate output data associated with the input data.

In S2 (extraction processing), at least one processor extracts the reference information, from the plurality of pieces of reference information the generation can be caused to refer to, based on the label indicating the attribute of each piece of reference information associated in advance with each of the plurality of pieces of reference information.

In S3 (generation control processing), at least one processor causes the generation model to refer to the reference information extracted in the extraction processing and generate output data associated with the reference information and the target data.

As described above, an information processing method according to the present exemplary example embodiment adopts a configuration in which at least one processor executes reception processing of receiving an input of target data as input data to a generation model subjected to machine learning to generate output data associated with the input data, extraction processing of extracting, from among a plurality of pieces of reference information the generation model can be caused to refer to, reference information based on a label that indicates an attribute of each piece of reference information associated in advance with each of the plurality of pieces of reference information, and generation control processing of causing the generation model to refer to the reference information extracted in the extraction processing and generate output data associated with the reference information and the target data. According to this information processing method, an effect is obtained that the accuracy of the output data generated by the generation model can be improved.

### Second Exemplary Example Embodiment

A second exemplary example embodiment that is an example of the example embodiments of the present disclosure will be described in detail with reference to the drawings. Components including the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### Configuration of Information Processing Device 1A

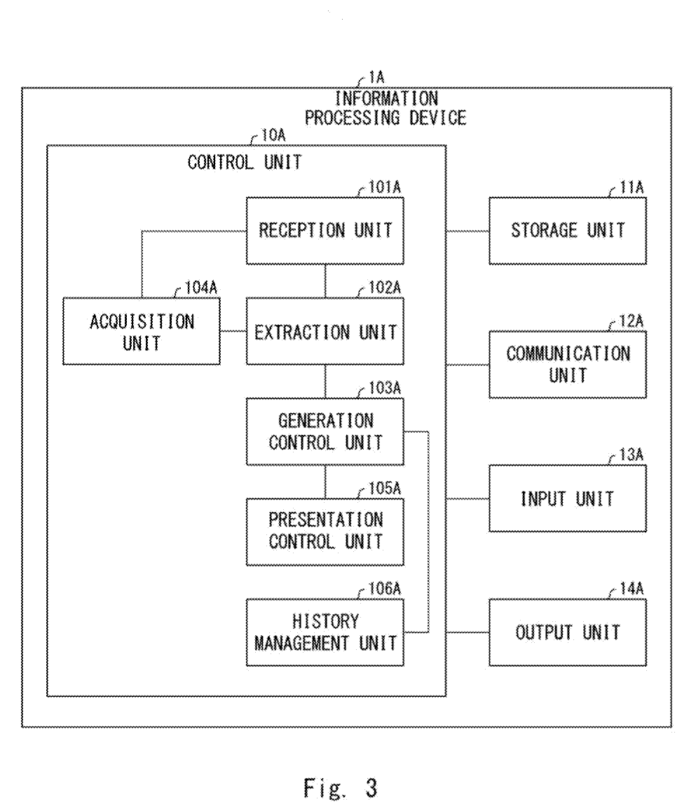

A configuration of an information processing device 1A according to the present exemplary example embodiment will be described with reference to FIG. 3. FIG. 3 is a block diagram illustrating a configuration of the information processing device 1A. The information processing device 1A is a device including a function of receiving input of target data by a user, causing a generation model to generate output data associated with the target data, and providing the generated output data to the user. The information processing device 1A may be a local device used by individual users, or may be a server that provides a generation service of output data to a plurality of users.

As illustrated, the information processing device 1A includes a control unit 10A for integrally controlling units of the information processing device 1A, and a storage unit 11A that stores various types of data to be used by the information processing device 1A. Furthermore, the information processing device 1A includes a communication unit 12A for the information processing device 1A to communicate with another device, an input unit 13A for receiving an input to the information processing device 1A, and an output unit 14A for the information processing device 1A to output data. Then, the control unit 10A includes a reception unit 101A, an extraction unit 102A, a generation control unit 103A, an acquisition unit 104A, a presentation control unit 105A, and a history management unit 106A.

Similarly to the reception unit 101 of the first exemplary example embodiment, the reception unit 101A receives an input of target data as input data for a generation model subjected to machine learning to generate output data associated with the input data. Hereinafter, an example in which a language model capable of performing natural language processing is used as the generation model will be described, and this language model will be referred to as a generation model 2A.

The language model capable of performing natural language processing can be generated by learning the arrangement of constituent elements (words etc.) in a sentence of a natural language and the arrangement of a sentence and a sentence in a writing. Examples of the language model capable of performing natural language processing include, for example, Bidirectional Encoder Representations from Transformers (BERT), Robustly optimized BERT approach (RoBERTa), Efficiently Learning an Encoder that Classifies Token Replacements Accurately (ELECTRA), and the like.

In the following, it is assumed that the target data is text data indicating the target content of sentence and the determination condition in the determination task of determining whether the target content of sentence satisfies the determination condition. In this case, by inputting the target data to the generation model 2A, an execution result of the determination task, that is, output data indicating whether the target content of sentence satisfies the determination condition is generated and output by the generation model 2A. The task to be executed by the generation model 2A is not limited to the determination task. For example, it is also possible to cause the generation model 2A to execute a task of generating an answer to a question, a classification task of classifying a designated target, an analysis task of analyzing the designated target, a prediction task of predicting the designated target, and the like.

The target content of sentence is a target for determination on the satisfiability of the determination condition. For example, it is assumed that it is desired to determine whether a product conforms to a predetermined standard from a specification of the product. In this case, a content of sentence indicating a requirement of a standard may be input to the information processing device 1A as the “determination condition”, and a content of sentence relating to the standard of the product in the specification of the product or the like may be input as the “target content of sentence”. As a result, it is possible to cause the information processing device 1A to generate a determination result as to whether the product conforms to the standard.

Furthermore, for example, a content of sentence describing a symptom of a certain disease may be referred to as the “determination condition”, and an explanatory sentence explaining the symptom of a subject who may be suffering from the disease may be referred to as the “target content of sentence”. In this case, it is possible to cause the information processing device 1A to generate a determination result as to whether the subject is suffering from the above-described disease. As described above, the information processing device 1A can also be used for healthcare application. The determination target is not limited to a content of sentence, that is, content in a text format, and may be content in a format other than text (e.g., image etc.).

Similarly to the extraction unit 102 of the first exemplary example embodiment, the extraction unit 102A extracts reference information from among a plurality of pieces of reference information the generation model can be caused to refer to, based on a label that indicates an attribute of each piece of reference information associated in advance with each of the plurality of pieces of reference information. Details of the extraction method will be described later.

Similarly to the generation control unit 103 of the first exemplary example embodiment, the generation control unit 103A causes the generation model 2A to refer to the reference information extracted by the extraction unit 102A and generate output data associated with the reference information and the target data. Specifically, the generation control unit 103A causes the generation model 2A to refer to the determination example extracted by the extraction unit 102A and generate a determination result associated with the determination example, and the determination condition and the target content of sentence received by the reception unit 101A. The determination result generated by the control of the generation control unit 103A is the execution result of the determination task, that is, the determination result regarding the satisfiability of the determination condition of the target content of sentence.

The generation control unit 103A does not need to cause the generation model 2A to refer to all of the determination examples extracted by the extraction unit 102A. For example, the generation control unit 103A may select a determination example to be referred to by the generation model 2A from among the determination examples extracted by the extraction unit 102A and cause the generation model 2A to refer to the selected determination example. The selection condition of the determination example is not particularly limited. For example, the generation control unit 103A may calculate the relevance degree between each of the plurality of determination examples extracted by the extraction unit 102A and the target data, and select a predetermined number of determination examples in which the calculated relevance degree is of high order as determination examples to be referred to by the generation model 2A. A method of calculating the relevance degree will be described later.

The acquisition unit 104A acquires attribute information indicating an attribute of a session for causing the generation model 2A to generate output data. Although details will be described later, the attribute information acquired by the acquisition unit 104A is used for extraction of the reference information by the extraction unit 102A.

Here, the “session for causing the generation model 2A to generate output data” refers to a series of processes for causing the generation model 2A to generate output data. Furthermore, the “attribute of session” may be any attribute related to the session. The “attribute information” can also be referred to as “profile”, “meta information”, or the like.

For example, the acquisition unit 104A may acquire attribute information indicating an attribute of the session itself such as a purpose of the session and a project in which the session is performed. Furthermore, for example, the acquisition unit 104A may acquire attribute information indicating at least one of an attribute of a person performing a session with the generation model 2A, an attribute of input data input to the generation model 2A in the session, and an attribute of output data output from the generation model 2A in the session.

A method for acquiring the attribute information is not particularly limited. For example, the acquisition unit 104A may acquire attribute information input by the user of the information processing device 1A. In this case, the user may input attribute information indicating an attribute related to a determination criterion to be applied to the generation model 2A in the session.

For example, it is assumed that the generation model 2A is caused to execute a determination task of determining whether a response to the response case has been appropriate in the response case regarding the cyber security. In this case, the user can cause the generation model 2A to execute the determination task with the determination example of the security management department of the company as the reference information by inputting the attribute information indicating the security management department of the company. The determination example of the security management department of the company is associated with a label indicating the department in advance.

The presentation control unit 105A performs processing of presenting various types of information to the user. For example, the presentation control unit 105A may present the determination condition and the target content of sentence received by the reception unit 101A to the user who has input them. Furthermore, the presentation control unit 105A may present output data associated with the determination condition and the target content of sentence, that is, the determination result generated by the generation model 2A to the user.

A mode of presentation of the information by the presentation control unit 105A is any mode. For example, the presentation control unit 105A may present information to the user by causing a display device to display and output the information, or may present information to the user by causing a voice output device to output information by voice.

Hereinafter, an example in which the presentation control unit 105A causes the display device to display and output information will be described. The device for outputting information may be a device included in the information processing device 1A (e.g., the output unit 14A) or a device external to the information processing device 1A (e.g., a terminal device or the like possessed by the user).

The history management unit 106A manages an input/output history of the generation model 2A. For example, the history management unit 106A records, as an input/output history, a set of the determination condition and the target content of sentence received by the reception unit 101A and the determination result generated by the generation model 2A, to which the attribute information acquired by the acquisition unit 104A is associated as a label. A recording destination of the input/output history is optional. For example, the history management unit 106A may record the input/output history in the storage unit 11A, or may record the input/output history in a database (e.g., a database 3A to be described later) or the like external to the information processing device 1A.

As described above, similarly to the information processing device 1 of the first exemplary example embodiment, the information processing device 1A includes the reception unit 101A for receiving an input of a determination condition of a determination task and a target content of sentence (target data) as input data to the generation model 2A subjected to machine learning to generate output data associated with the input data, the extraction unit 102A for extracting a determination example, from among a plurality of determination examples (reference information) the generation model 2A can be caused to refer to, based on a label indicating an attribute of each determination example associated in advance with each of the plurality of determination examples, and the generation control unit 103 for causing the generation model 2A to refer to the determination example extracted by the extraction unit 102A and generate a determination result (output data) associated with the determination example, the determination condition and the target content of sentence. Therefore, an effect is obtained that the accuracy of determination by the generation model 2A can be improved.

The target data in the present exemplary example embodiment is not limited to the determination condition and the target content of sentence in the determination task. Furthermore, the target of extraction by the extraction unit 102A is not limited to the determination example. That is, the “determination condition and target content of sentence (in the determination task)”, the “determination condition”, and the “target content of sentence” in the present exemplary example embodiment can be read as any “target data”. In addition, the “determination example” in the present exemplary example embodiment can be read as any “reference information”.

Furthermore, as described above, the information processing device 1A includes the presentation control unit 105A for presenting the determination result (output data of the generation model 2A) generated by the generation model 2A. As a result, in addition to the effect obtained by the information processing device 1, an effect is obtained that the user or the like of the information processing device 1A can recognize the determination result generated by the generation model 2A.

### Execution Example of Determination Task

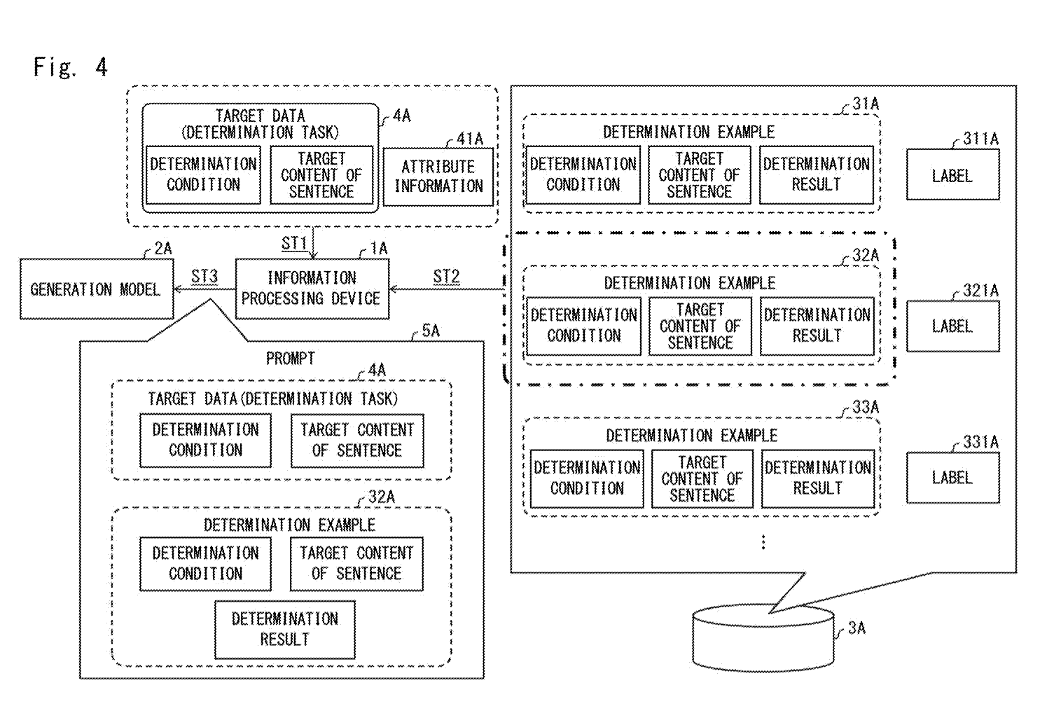

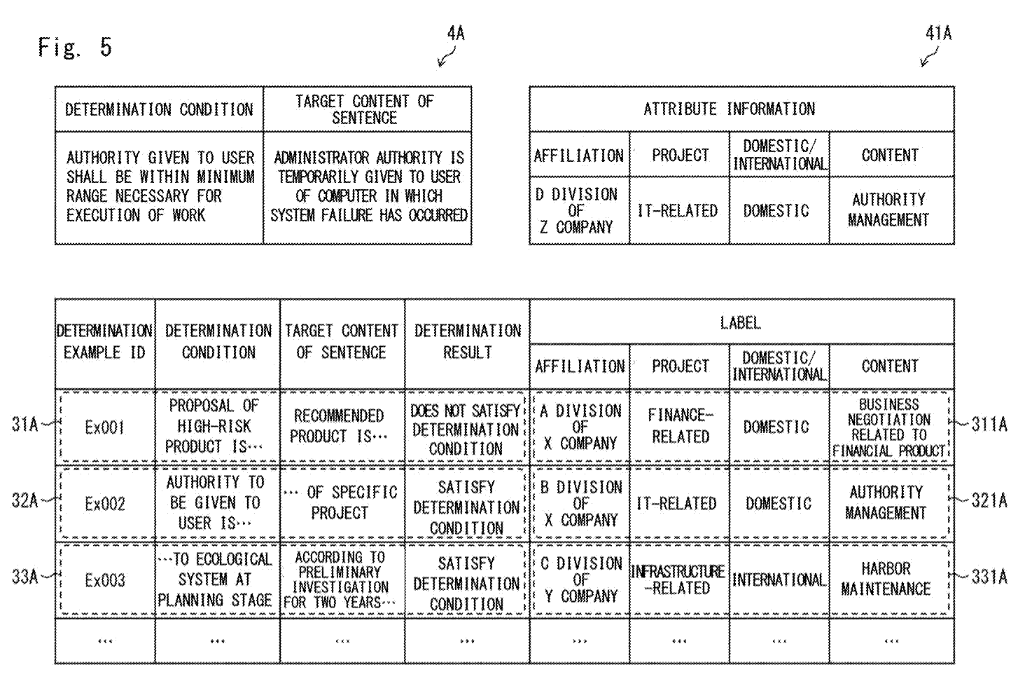

An execution example of the determination task will be described with reference to FIGS. 4 and 5. FIG. 4 is a diagram illustrating an execution example of a determination task by the information processing device 1A. Furthermore, FIG. 5 is a diagram illustrating an example of various types of data used for the determination task.

In ST1 of FIG. 4, a determination condition and a target content of sentence in the determination task are input to the information processing device 1A as target data 4A. In addition, in the example of FIG. 4, attribute information 41A is input to the information processing device 1A in addition to the target data 4A. The input of the target data 4A and the attribute information 41A is received by the reception unit 101A, and the received attribute information 41A is acquired by the acquisition unit 104A.

The target data 4A may be, for example, as illustrated in FIG. 5. The target data 4A illustrated in FIG. 5 includes a determination condition of “the authority given to the user shall be within a minimum range necessary for execution of a work” and a target content of sentence of “the administrator authority is temporarily given to the user of the computer in which the system failure has occurred”. Furthermore, the attribute information 41A may also be as illustrated in FIG. 5. The attribute information 41A illustrated in FIG. 5 indicates the affiliation of the user, the attribute of the project, whether the determination is made in a domestic case or an international case, and the classification of the content of the task. These are examples of the attribute information indicating the attribute of the session in which the user causes the generation model 2A to generate the output data. As in the example of FIG. 5, the attributes may be classified into a plurality of categories.

In ST2, a determination example associated with the attribute information 41A is extracted from a plurality of determination examples such as the determination examples 31A, 32A, and 33A recorded in the database 3A. Specifically, in the example of FIG. 4, the determination example 32A is extracted. The extraction of the determination example 32A is performed by the extraction unit 102A.

In this manner, the extraction unit 102A may extract the determination example from the database 3A that records the determination example (reference information) and the label in association with each other. As a result, in addition to the effect obtained by the information processing device 1, an effect is obtained that similar criterion as the determination example (reference information) recorded in the database 3A can be applied to the determination (generation of output data) by the generation model 2A.

The determination example recorded in the database 3A may be a determination example by the generation model 2A, may be a determination example by another generation model, or may include both of them. In addition, the determination example recorded in the database 3A may include a determination example obtained by correcting the determination example by the generation model 2A or another generation model by a person, or may include a determination example by a person. The determination examples recorded in the database 3A may include those with different determination criteria. However, in this case, it is desirable to give a label indicating a common attribute to determination examples including a common determination criterion.

The determination example recorded in the database 3A may be, for example, as illustrated in FIG. 5. A table illustrated on the lower side of FIG. 5 illustrates a specific example of a determination example recorded in the database 3A. In the table, a determination condition, a target content of sentence, a determination result, and a label are associated with each determination example identification (ID) that is identification information of a determination example. Determination examples “Ex001” to “Ex003” in FIG. 5 correspond to determination examples 31A to 33A in FIG. 4. Furthermore, the labels associated with the determination examples of “Ex001” to “Ex003” in FIG. 5 correspond to the labels 311A to 331A in FIG. 4.

The determination examples 31A to 33A illustrated in FIG. 5 each include a determination condition and a target content of sentence, and also include a determination result. That is, the determination examples 31A to 33A illustrate a determination task of determining whether the target content of sentence satisfies the determination condition and a determination result thereof. In addition, the labels 311A to 331A illustrated in FIG. 5 indicate attributes of a plurality of categories such as “affiliation” and “project”, similarly to the attribute information 43A illustrated in the figure. As in this example, the label given to the determination example preferably indicates an attribute that can be related to the determination criterion in the determination example.

The determination result may include a basis of the determination. Since the basis of the determination can also be said to indicate the determination criterion, it is possible to more accurately reflect the determination criterion of the determination example in the determination task by causing the generation model 2A to refer to the determination result including the basis of the determination.

Based on the attribute information 41A and the labels 311A to 331A as described above, the extraction unit 102A extracts a determination example to be referred to by the generation model 2A from among the determination examples 31A to 33A. For example, the extraction unit 102A may extract reference information to which a label indicating the attribute same as the attribute indicated in the attribute information 41A is given.

Furthermore, as in the example of FIG. 5, a plurality of attributes may be indicated in the label given to each determination example. In addition, the acquisition unit 104A may acquire the attribute information 41A (or the plurality of pieces of attribute information 41A) indicating a plurality of attributes. In the case of any one or both of these, the extraction unit 102A may extract a determination example to which a label including at least one attribute that matches is given. Furthermore, the extraction unit 102A may extract a determination example to which a label including a predetermined number or more of attributes that match is given.

For example, in the example of FIG. 5, three attributes of “project”, “national/international”, and “content” match between the attribute information 41A and the determination example 32A. On the other hand, the attribute information 41A and the determination example 31A match in the “national/international” attribute, and the attribute information 41A and the determination example 33A do not have a matching attribute. In this case, for example, if the extraction condition is that “two or more attributes match”, the extraction unit 102A extracts the determination example 32A among the determination examples 31A to 33A. On the other hand, for example, if the extraction condition is that “one or more attributes match”, the extraction unit 102A extracts the determination examples 31A and 32A among the determination examples 31A to 33A.

However, the attribute indicated in the attribute information acquired by the acquisition unit 104A and the attribute indicated in the label are not necessarily given based on the same standard. For this reason, regarding the similar attribute, the expression may be different between the attribute information and the label. Therefore, the extraction unit 102A may acquire reference information to which a label indicating an attribute associated with the attribute indicated in the attribute information acquired by the acquisition unit 104A is given.

For example, the extraction unit 102A may calculate a relevance degree, that is a degree at which the attribute indicated in the attribute information and the attribute indicated in the label are relevant to each other, for each piece of related information, and extract the reference information based on the calculated relevance degree. As a result, in addition to the effects obtained by the information processing device 1, an effect is obtained that a related determination example (reference information) can be extracted even if the attribute indicated in the attribute information and the attribute indicated in the label are not necessarily given based on the same standard.

A method for calculating the relevance degree is not particularly limited. For example, in a case where the attribute is represented by a character, the extraction unit 102A may calculate a matching degree of characters representing the attribute and a similarity of a character string representing the attribute as the relevance degree. The matching degree of the characters representing the attribute can be represented by, for example, the number of matching characters (e.g., two characters in the case of “financial product” and “financial service”). Furthermore, the similarity of the character string representing the attribute can be represented by the maximum number of characters (e.g., eight characters in the case of “business negotiation related to financial products” and “business negotiation related to insurance products”) among the matching character strings. With these configurations, it is possible to extract a determination example (reference information) to which an attribute in which the attribute indicated in the label partially matches the character string is associated.

Furthermore, for example, the extraction unit 102A may convert an attribute into vector expression by Word2Vec or the like, and then calculate similarity between vectors as the relevance degree. The similarity between the vectors can be expressed by, for example, cosine similarity or the like. In addition to this, for example, the extraction unit 102A may input two attributes for which the relevance degree is to be obtained to a language model capable of performing natural language processing, and output an estimation result of the relevance degree of the attributes.

Furthermore, the extraction unit 102A may generate a sentence describing one or a plurality of attributes indicated in the label, generate a sentence describing one or a plurality of attributes indicated in the label, and calculate the relevance degree of the generated sentence. As a result, in addition to the effect obtained by the information processing device 1, an effect is obtained that the relevance degree in consideration of the relevance between the attributes can be calculated.

For example, the extraction unit 102A can generate a sentence “determination task regarding authority management in domestic IT-related projects by the D division of the Z company” using the attribute information 41A illustrated in FIG. 5. Similarly, the extraction unit 102A can generate sentences of “determination task for business negotiation on financial products in domestic finance-related projects by A division of X company”, “determination task on authority management in domestic IT-related projects by B division of X company”, and “determination task on harbor maintenance in international infrastructure-related project by C division of Y company”, respectively, using the labels 311A to 331A illustrated in FIG. 5. These sentences can be generated, for example, by inputting attributes to a template, or can be generated by a model capable of performing natural language processing such as the generation model 2A. Then, the extraction unit 102A may convert each generated sentence into vector expression by Word2Vec or the like, and calculate similarity between vectors as the relevance degree.

In ST3 of FIG. 4, in addition to the target data 4A including the determination condition and the target content of sentence, a prompt 5A including the determination example 32A extracted by the extraction unit 102A through the above processing is input to the generation model 2A. The generation of the prompt 5A and the input to the generation model 2A are performed by the generation control unit 103A.

A method for generating the prompt 5A is not particularly limited. For example, the generation control unit 103A can generate the prompt 5A by incorporating the determination condition and the target content of sentence indicated in the target data 4A and the determination example 32A extracted by the extraction unit 102A into a predetermined template. The template may be, for example, “Please determine whether the [target content of sentence] to which the determination criterion in the [determination example] has been applied satisfies the [determination condition], and answer the determination result”. The prompt 5A can be generated by incorporating the determination condition and the target content of sentence indicated in the target data 4A and the determination example 32A (more specifically, the target content of sentence, the determination condition, and the determination result in the determination example 32A) in the portions of [determination condition], [target content of sentence], and [determination example] in this template.

Furthermore, for example, the generation control unit 103A may input the determination condition and the target content of sentence indicated in the target data 4A and the determination example 32A to a model capable of performing natural language processing such as the generation model 2A, apply the determination criterion in the determination example 32A, and generate the prompt 5A for instructing to determine whether the target content of sentence indicated in the target data 4A similarly satisfies the determination condition indicated in the target data 4A.

Furthermore, for example, the generation control unit 103A may generate a prompt for instructing to output the basis of the determination result together with the determination result. By using such a prompt, it is possible to cause the generation model 2A to generate the determination result and the basis thereof. As described above, the basis for the determination is useful in clarifying the criterion for the determination.

As described above, the information processing device 1A includes the acquisition unit 104A for acquiring the attribute information 43A indicating the attribute of the session for which the generation model 2A is caused to generate the output data, and the extraction unit 102A extracts, from the reference information indicating the input/output example including the combination of the input data and the output data, at least one of the reference information to which the label indicating the same attribute as the attribute indicated in the attribute information 43A acquired by the acquisition unit 104A is given and the reference information to which the label indicating the attribute associated with the attribute indicated in the attribute information 43A acquired by the acquisition unit 104A is given. As a result, in addition to the effect obtained by the information processing device 1, an effect is obtained that an input/output example related to the current session can be extracted as the reference information and the input/output example can be reflected in the output data.

As described above, the generation control unit 103A may input the determination example (input/output example) extracted by the extraction unit 102A to the generation model 2A together with the determination condition and the target content of sentence of the target data 4A to cause the generation model 2A to refer to the determination example. As a result, the determination example (input/output example) can be reflected in the determination result (output data) output by the generation model 2A.

Furthermore, the generation control unit 103A may cause the generation model 2A to refer to the determination example by inputting the determination example (input/output example) extracted by the extraction unit 102A to the generation model 2A as the input/output history of the generation model 2A. Even in a case where this configuration is adopted, the determination example can be reflected in the determination result (output data) output by the generation model 2A.

For example, the generation control unit 103A may generate an input/output history in which the target content of sentence and the determination condition in the determination example 32A extracted by the extraction unit 102A are input by the user and the determination result is generated by the generation model 2A, and input the input/output history to the generation model 2A. As a result, it is possible to cause the generation model 2A to generate the determination result for the determination task defined by the target data 4A on the assumption that the target content of sentence and the determination condition in the determination example 32A have been input and the determination result has been generated.

In the example of FIG. 4, the determination condition and the target content of sentence indicated in the target data 4A and the determination example 32A are included in one prompt 5A, but these pieces of information may be dispersed to a plurality of prompts.

### Screen Example

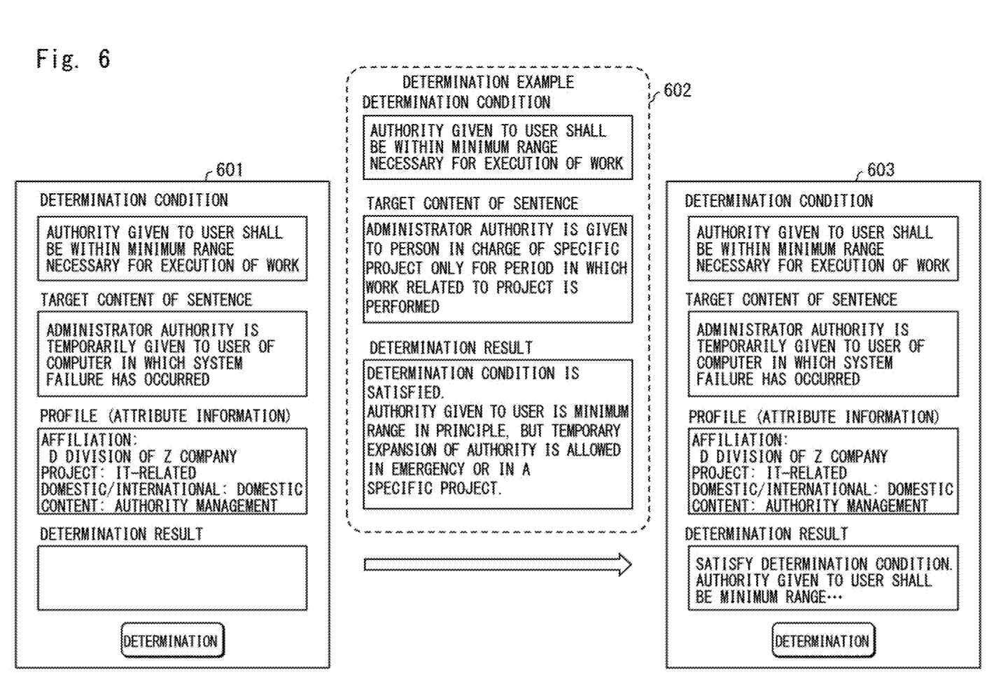

FIG. 6 is a diagram illustrating an example of a display screen displayed at the time of execution of the determination task by the information processing device 1A. More specifically, reference numeral 601 in FIG. 6 denotes a display screen example at the time point the determination condition and the target content of sentence are input, and reference numeral 603 denotes a display screen example that presents the determination result. Such a display screen is presented to the user by the presentation control unit 105A. Reference numeral 602 in FIG. 6 denotes a determination example referred to in generating the determination result. The determination example 602 does not need to be presented to the user.

The screen example 601 includes an input item for receiving an input of a determination condition, an input item for receiving an input of a target content of sentence, an input item for receiving an input of a profile (associated with the above-described attribute information), and an item for displaying a determination result. The reception unit 101A may receive the input of the determination condition, the target content of sentence, and the attribute information via such a User Interface (UI) screen. In the example of FIG. 6, a check item related to cyber security is input as a determination condition, and a content of sentence describing an action to be checked from the viewpoint of cyber security is input as a target content of sentence. In addition, attribute information indicating that the affiliation of the user is “D division of Z company” and this session is a session for “authority management” in the “domestic” “IT-related” project is input.

In a case where a “determination” button (software key) in the screen example 601 is operated, extraction of a determination example is started. In the example of FIG. 6, the attribute information input to the screen example 601 is the same as the attribute information 41A illustrated in FIGS. 4 and 5. Therefore, the determination example 32A is extracted as in the example of FIG. 4.

In a case where the determination example 602 is extracted, the generation control unit 103A causes the generation model 2A to execute the determination task with reference to the determination example 602. Then, the presentation control unit 105A presents the determination result to the user. Specifically, the presentation control unit 105A causes the determination result output by the generation model 2A to be displayed in the item for displaying the determination result in the screen example 601. As a result, the screen example 601 presented to the user is updated to the screen example 603.

The determination result shown in the screen example 603 reflects the determination criterion in the determination example 602. That is, the determination criterion in the determination example 602 is that the authority given to the user is in a minimum range in principle, but temporary expansion of the authority is allowed in an emergency or in a specific project. In the example of FIG. 6, by applying this determination criterion, a determination result indicating that the determination condition is satisfied is obtained for an action that can be determined not to satisfy the determination condition that the administrator authority is temporarily given to the user of the computer in which the system failure has occurred.

### Automatic Acquisition of Attribute Information

The acquisition unit 104A may automatically acquire the attribute information regardless of the user's input. For example, the acquisition unit 104A may acquire a domain name indicated in an e-mail address of an inputter of the target data as the attribute information. The domain name is a name for identifying a specific place or resource on the Internet, and is often a character string associated with an organization or the like to which the inputter belongs. Therefore, a determination example (reference information) associated with the organization or the like to which the inputter belongs can be extracted by acquiring the domain name as the attribute information. Therefore, according to the above configuration, in addition to the effects obtained by the information processing device 1, an effect is obtained that a valid determination example (reference information) can be extracted regardless of the user's input.

Furthermore, for example, the acquisition unit 104A may acquire attribute information indicating an attribute of a predetermined project advanced using the output data generated by the generation model 2A. This makes it possible to extract a determination example (reference information) associated with a project that the user is working on. Therefore, according to the above configuration, in addition to the effects obtained by the information processing device 1, an effect is obtained that a valid determination example (reference information) can be extracted regardless of the user's input.

A method of acquiring the attribute information indicating the attribute of the project is not particularly limited. For example, the attribute of the project may be recorded in a predetermined recording destination, and the record may be appropriately updated according to the project that the user is working on. As a result, the acquisition unit 104A can acquire the attribute information indicating the attribute of the project with reference to the recording destination.

### Flow of Processing

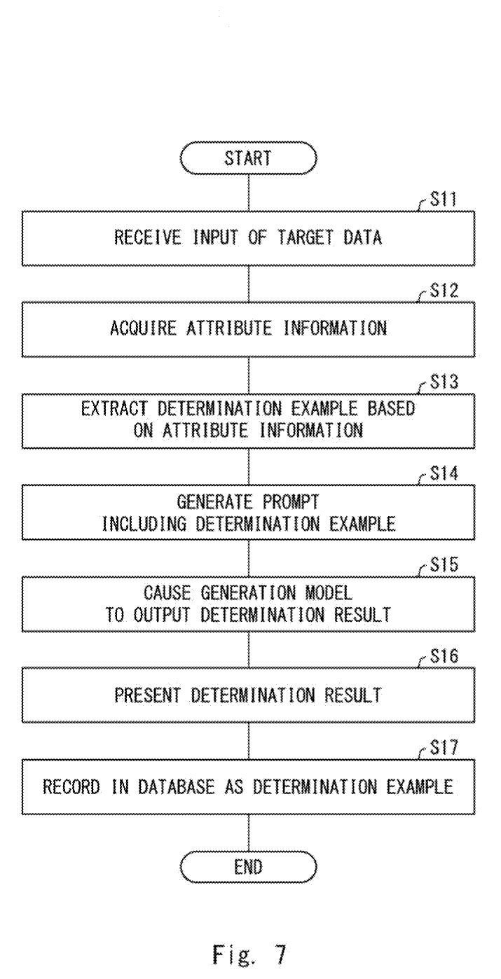

A flow of processing executed by the information processing device 1A will be described with reference to FIG. 7. FIG. 7 is a flowchart illustrating a flow of processing executed by the information processing device 1A. The flowchart of FIG. 7 includes each processing of the information processing method of the present exemplary example embodiment.

In S11 reception processing, the reception unit 101A receives the input of the target data as the input data to the generation model 2A subjected to machine learning to generate the output data associated with the input data. Specifically, the reception unit 101A receives the determination condition and the target content of sentence in the determination task as the target data. In addition, the reception unit 101A may also receive an input of attribute information indicating an attribute of a session for causing the generation model 2A to generate output data.

In S12, the acquisition unit 104A acquires attribute information indicating the attribute of the session. For example, in a case where the input of the attribute information is received in S11, the acquisition unit 104A acquires the input attribute information. Furthermore, as described above, the acquisition unit 104A may automatically acquire the attribute information. The acquisition unit 104A may acquire the input attribute information and automatically acquire the attribute information.

In S13 extraction processing, the extraction unit 102A extracts a determination example, from a plurality of determination examples the generation model 2A can be caused to refer to, based on a label indicating an attribute of each determination example associated in advance with each of the plurality of determination examples. For example, the extraction unit 102A may extract a determination example in which a label indicating the same attribute as or a corresponding attribute as the attribute indicated in the attribute information acquired in S12 is given among the determination examples recorded in the database 3A.

In S14, the generation control unit 103A generates a prompt including the determination example extracted in S13. More specifically, the generation control unit 103A generates a prompt for instructing to determine whether the target content of sentence satisfies the determination condition by including the determination example extracted in S13 and the determination condition and the target content of sentence of the target data received in S11 and applying the determination criterion in the determination example.

In S15 (generation control processing), the generation control unit 103A causes the generation model 2A to refer to the determination example extracted in S13, and generate output data, that is, a determination result of the determination task associated with the determination example and the determination condition and the target content of sentence received in S11. Specifically, the generation control unit 103A inputs the prompt generated in S14 to the generation model 2A and causes the generation model to output the determination result.

In S16, the presentation control unit 105A presents the determination result of S15 to the user. In addition, in S17, the history management unit 106A associates the determination result in S15 with the determination condition and the target content of sentence of the target data received in S11, and records them in the database 3A as a new determination example. Furthermore, the history management unit 106A records the attribute information acquired in S12 as the label of the recorded determination example. Accordingly, the processing of FIG. 7 ends.

In S17, a condition may be provided in the determination example to be recorded in the database 3A. For example, the history management unit 106A may record, in the database 3A, a determination example that satisfies at least either the user giving a positive feedback on the determination result presented in S16, or the user not giving a negative feedback on the determination result presented in S16. As a result, a case determined to be valid by the user or a case determined not to be invalid by the user can be recorded as a determination example. Then, it becomes possible to increase the possibility of generating a determination result complying with the intention of the user by causing the generation model 2A to refer to such a determination example.

Furthermore, the reception unit 101A may receive correction of the user on the determination result presented in S16. In this case, the history management unit 106A records the corrected determination result in the database 3A in association with the determination condition and the target content of sentence received in S11. In this case as well, it becomes possible to increase the possibility of generating a determination result complying with the intention of the user.

### Modified Examples

An executing entity of each processing described in the above-described exemplary example embodiments is optional, and is not limited to the above-described examples. For example, a system including functions similar to those of the information processing devices 1 and 1A can be constructed by a plurality of devices capable of communicating with each other. The executing entity of each processing illustrated in the flowchart of FIG. 7 may be one device (may be rephrased as a processor) or a plurality of devices (may be similarly rephrased as processors).

### Example of Implementation by Software

Some or all of the functions of the information processing devices 1 and 1A (hereinafter, also referred to as “each of the above devices”) may be implemented by hardware such as an integrated circuit (IC chip) or may be implemented by software.

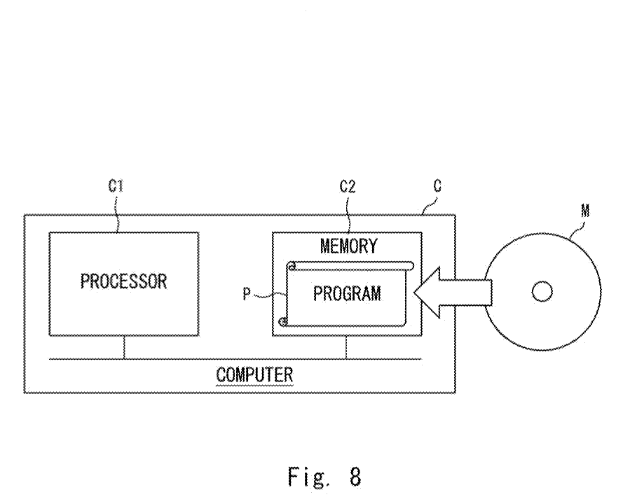

In the latter case, each of the above devices is implemented by, for example, a computer that executes commands of a program, that is software for implementing each function. An example of such a computer (hereinafter, referred to as a computer C) is illustrated in FIG. 8. FIG. 8 is a block diagram illustrating a hardware configuration of the computer C functioning as each of the above devices.

The computer C includes at least one processor C1 and at least one memory C2. A program (information processing program) P for operating the computer C as each of the above devices is recorded in the memory C2. In the computer C, the processor C1 reads the program P from the memory C2 and executes the program P to implement each function of each of the above devices.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

The program P can be stored and provided to a computer using any type of non-transitory computer readable media M. Non-transitory computer readable media M include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM, etc.). The program P may be provided to the computer C using any type of transitory computer readable media. Examples of transitory computer readable media include electric signals, optical signals, and electromagnetic waves. Transitory computer readable media can provide the program P to the computer C via a wired communication line (e.g. electric wires, and optical fibers) or a wireless communication line.

Each of the above functions of each of the above devices may be implemented by a single processor provided in a single computer, may be implemented in cooperation with a plurality of processors provided in a single computer, or may be implemented in cooperation with a plurality of processors provided in a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information A

The present disclosure includes the techniques described in the following supplementary notes. However, the present disclosure is not limited to the techniques described in the following supplementary notes, and various modifications can be made within the scope described in the claims.

### Supplementary Note A1

An information processing device including

a reception means for receiving an input of target data as input data to a generation model subjected to machine learning to generate output data associated with the input data,

an extraction means for extracting reference information, from a plurality of pieces of reference information the generation model can be caused to refer to, based on a label that indicates an attribute of each piece of reference information associated in advance with each of the plurality of pieces of reference information, and

a generation control means for causing the generation model to refer to the reference information extracted by the extraction means and generate output data associated with the reference information and the target data.

### Supplementary Note A2

The information processing device according to supplementary note A1, further including

an acquisition means for acquiring attribute information indicating an attribute of a session for causing the generation model to generate output data, in which

the extraction means extracts at least one of reference information to which a label indicating an attribute same as the attribute indicated in the attribute information is given and reference information to which a label indicating an attribute associated with the attribute indicated in the attribute information is given, from reference information indicating an input/output example including a combination of input data and output data.

### Supplementary Note A3

The information processing device according to supplementary note A2, in which the acquisition means acquires a domain name indicated in an e-mail address of an inputter of the target data as the attribute information.

### Supplementary Note A4

The information processing device according to supplementary note A2 or A3, in which the acquisition means acquires attribute information indicating an attribute of a predetermined project advanced using output data generated by the generation model.

### Supplementary Note A5

The information processing device according to any one of supplementary notes A2 to A4, in which the extraction means calculates, for each piece of related information, a relevance degree that is a relevance degree between the attribute indicated in the attribute information and the attribute indicated in the label, and extracts reference information based on the calculated relevance degree.

### Supplementary Note A6

The information processing device according to supplementary note A5, in which the extraction means generates a sentence describing one or a plurality of attributes indicated in the attribute information, generates a sentence describing one or a plurality of attributes indicated in the label, and calculates a relevance degree of the generated sentences.

### Supplementary Note A7

The information processing device according to any one of supplementary notes A1 to A6, further including a presentation control means for presenting the output data generated by the generation model.

### Supplementary Note A8

The information processing device according to any one of supplementary notes A1 to A7, in which the extraction means extracts reference information from a database recording the reference information and the label in association with each other.

### Supplementary Information B

The present disclosure includes the techniques described in the following supplementary notes. However, the present disclosure is not limited to the techniques described in the following supplementary notes, and various modifications can be made within the scope described in the claims.

### Supplementary Note B1

An information processing method, in which at least one processor executes

reception processing of receiving an input of target data as input data to a generation model subjected to machine learning to generate output data associated with the input data,

extraction processing of extracting reference information, from a plurality of pieces of reference information the generation model can be caused to refer to, based on a label that indicates an attribute of each piece of reference information associated in advance with each of the plurality of pieces of reference information, and

generation control processing of causing the generation model to refer to the reference information extracted in the extraction processing and generate output data associated with the reference information and the target data.

### Supplementary Note B2

The information processing method according to supplementary note B1, in which

the at least one processor further executes acquisition processing of acquiring attribute information indicating an attribute of a session for causing the generation model to generate output data, and

in the extraction processing, the at least one processor extracts at least one of reference information to which a label indicating an attribute same as the attribute indicated in the attribute information is given and reference information to which a label indicating an attribute associated with the attribute indicated in the attribute information is given, from reference information indicating an input/output example including a combination of input data and output data.

### Supplementary Note B3

The information processing method according to supplementary note B2, in which in the acquisition processing, the at least one processor acquires a domain name indicated in an e-mail address of an inputter of the target data as the attribute information.

### Supplementary Note B4

The information processing method according to supplementary note B2 or B3, in which in the acquisition processing, the at least one processor acquires attribute information indicating an attribute of a predetermined project advanced using output data generated by the generation model.

### Supplementary Note B5

The information processing method according to any one of supplementary notes B2 to B4, in which in the extraction processing, the at least one processor calculates, for each piece of related information, a relevance degree that is a relevance degree between the attribute indicated in the attribute information and the attribute indicated in the label, and extracts reference information based on the calculated relevance degree.

### Supplementary Note B6

The information processing method according to supplementary note B5, in which in the extraction processing, the at least one processor generates a sentence describing one or a plurality of attributes indicated in the attribute information, generates a sentence describing one or a plurality of attributes indicated in the label, and calculates a relevance degree of the generated sentences.

### Supplementary Note B7

The information processing method according to any one of supplementary notes B1 to B6, in which the at least one processor further executes presentation control processing of presenting the output data generated by the generation model.

### Supplementary Note B8

The information processing method according to any one of supplementary notes B1 to B7, in which in the extraction processing, the at least one processor extracts reference information from a database recording the reference information and the label in association with each other.

### Supplementary Information C

The present disclosure includes the techniques described in the following supplementary notes. However, the present disclosure is not limited to the techniques described in the following supplementary notes, and various modifications can be made within the scope described in the claims.

### Supplementary Note C1

An information processing program for causing a computer to function as

a reception means for receiving an input of target data as input data to a generation model subjected to machine learning to generate output data associated with the input data,

an extraction means for extracting reference information, from a plurality of pieces of reference information the generation model can be caused to refer to, based on a label that indicates an attribute of each piece of reference information associated in advance with each of the plurality of pieces of reference information, and

a generation control means for causing the generation model to refer to the reference information extracted by the extraction means and generate output data associated with the reference information and the target data.

### Supplementary Note C2

The information processing program according to supplementary note C1, further causing the computer to function as

an acquisition means for acquiring attribute information indicating an attribute of a session for causing the generation model to generate output data, in which

the extraction means extracts at least one of reference information to which a label indicating an attribute same as the attribute indicated in the attribute information is given and reference information to which a label indicating an attribute associated with the attribute indicated in the attribute information is given, from reference information indicating an input/output example including a combination of input data and output data.

### Supplementary Note C3

The information processing program according to supplementary note C2, in which the acquisition means acquires a domain name indicated in an e-mail address of an inputter of the target data as the attribute information.

### Supplementary Note C4

The information processing program according to supplementary note C2 or C3, in which the acquisition means acquires attribute information indicating an attribute of a predetermined project advanced using output data generated by the generation model.

### Supplementary Note C5

The information processing program according to any one of supplementary notes C2 to C4, in which the extraction means calculates, for each piece of related information, a relevance degree that is a relevance degree between the attribute indicated in the attribute information and the attribute indicated in the label, and extracts reference information based on the calculated relevance degree.

### Supplementary Note C6

The information processing program according to supplementary note C5, in which the extraction means generates a sentence describing one or a plurality of attributes indicated in the attribute information, generates a sentence describing one or a plurality of attributes indicated in the label, and calculates a relevance degree of the generated sentences.

### Supplementary Note C7

The information processing program according to any one of supplementary notes C1 to C6, further causing the computer to function as

a presentation control means for presenting the output data generated by the generation model.

### Supplementary Note C8

The information processing program according to any one of supplementary notes C1 to C7, in which the extraction means extracts reference information from a database recording the reference information and the label in association with each other.

### Supplementary Information D

The present disclosure includes the techniques described in the following supplementary notes. However, the present disclosure is not limited to the techniques described in the following supplementary notes, and various modifications can be made within the scope described in the claims.

### Supplementary Note D1

An information processing device including at least one processor, in which the at least one processor executes

reception processing of receiving an input of target data as input data to a generation model subjected to machine learning to generate output data associated with the input data,

extraction processing of extracting reference information, from a plurality of pieces of reference information the generation model can be caused to refer to, based on a label that indicates an attribute of each piece of reference information associated in advance with each of the plurality of pieces of reference information, and

generation control processing of causing the generation model to refer to the reference information extracted in the extraction processing and generate output data associated with the reference information and the target data.

The information processing device may further include a memory. The memory may store a program for causing the at least one processor to execute each processing.

### Supplementary Note D2

The information processing device according to supplementary note D1, in which

the at least one processor further executes acquisition processing of acquiring attribute information indicating an attribute of a session for causing the generation model to generate output data, and

in the extraction processing, the at least one processor extracts at least one of reference information to which a label indicating an attribute same as the attribute indicated in the attribute information is given and reference information to which a label indicating an attribute associated with the attribute indicated in the attribute information is given, from reference information indicating an input/output example including a combination of input data and output data.

### Supplementary Note D3

The information processing device according to supplementary note D2, in which in the acquisition processing, the at least one processor acquires a domain name indicated in an e-mail address of an inputter of the target data as the attribute information.

### Supplementary Note D4

The information processing device according to supplementary note D2 or D3, in which in the acquisition processing, the at least one processor acquires attribute information indicating an attribute of a predetermined project advanced using output data generated by the generation model.

### Supplementary Note D5

The information processing device according to any one of supplementary notes D2 to D4, in which in the extraction processing, the at least one processor calculates, for each piece of related information, a relevance degree that is a relevance degree between the attribute indicated in the attribute information and the attribute indicated in the label, and extracts reference information based on the calculated relevance degree.

### Supplementary Note D6

The information processing device according to supplementary note D5, in which in the extraction processing, the at least one processor generates a sentence describing one or a plurality of attributes indicated in the attribute information, generates a sentence describing one or a plurality of attributes indicated in the label, and calculates a relevance degree of the generated sentences.

### Supplementary Note D7

The information processing device according to any one of supplementary notes D1 to D6, in which the at least one processor further executes

presentation control processing of presenting the output data generated by the generation model.

### Supplementary Note D8

The information processing device according to any one of supplementary notes D1 to D7, in which in the extraction processing, the at least one processor extracts reference information from a database recording the reference information and the label in association with each other.

### Supplementary Information E

The present disclosure includes the techniques described in the following supplementary notes. However, the present disclosure is not limited to the techniques described in the following supplementary notes, and various modifications can be made within the scope described in the claims.

### Supplementary Note E1

A non-transitory recording medium recorded with an information processing program for causing a computer to function as an information processing device, the information processing program causing the computer to execute

reception processing of receiving an input of target data as input data to a generation model subjected to machine learning to generate output data associated with the input data,

extraction processing of extracting reference information, from a plurality of pieces of reference information the generation model can be caused to refer to, based on a label that indicates an attribute of each piece of reference information associated in advance with each of the plurality of pieces of reference information, and

generation control processing of causing the generation model to refer to the reference information extracted in the extraction processing and generate output data associated with the reference information and the target data.

1. An information processing device comprising:
at least one memory storing instructions, and
at least one processor configured to execute the instructions to;
receive an input of target data as input data to a generation model subjected to machine learning to generate output data associated with input data;
extract reference information, from a plurality of pieces of reference information the generation model can be caused to refer to, based on a label that indicates an attribute of each piece of reference information associated in advance with each of the plurality of pieces of reference information; and
cause the generation model to refer to the extracted reference information and generate output data associated with the reference information and the target data.

2. The information processing device according to claim 1, wherein the at least one processor is further configured to execute the instruction to:
acquire attribute information indicating an attribute of a session for causing the generation model to generate output data; and
extract at least one of reference information to which a label indicating an attribute same as the attribute indicated in the attribute information is given and reference information to which a label indicating an attribute associated with the attribute indicated in the attribute information is given, from reference information indicating an input/output example including a combination of input data and output data.

3. The information processing device according to claim 2, wherein the at least one processor is further configured to execute the instructions to acquire a domain name indicated in an e-mail address of an inputter of the target data as the attribute information.

4. The information processing device according to claim 2, wherein the at least one processor is further configured to execute the instructions to acquire attribute information indicating an attribute of a predetermined project advanced using output data generated by the generation model.

5. The information processing device according to claim 2, wherein the at least one processor is further configured to execute the instructions to calculate, for each piece of related information, a relevance degree that is a degree relevant between the attribute indicated in the attribute information and the attribute indicated in the label, and extracts reference information based on the calculated relevance degree.

6. The information processing device according to claim 5, wherein the at least one processor is further configured to execute the instructions to generate a sentence describing one or a plurality of attributes indicated in the attribute information, generate a sentence describing one or a plurality of attributes indicated in the label, and calculate a relevance degree of the generated sentences.

7. The information processing device according to claim 1, wherein the at least one processor is further configured to execute the instructions to present the output data generated by the generation model.

8. The information processing device according to claim 1, wherein the at least one processor is further configured to execute the instructions to extract reference information from a database recording the reference information and the label in association with each other.

9. An information processing method, in which at least one processor executes:
reception processing of receiving an input of target data as input data to a generation model subjected to machine learning to generate output data associated with input data;
extraction processing of extracting reference information, from a plurality of pieces of reference information the generation model can be caused to refer to, based on a label that indicates an attribute of each piece of reference information associated in advance with each of the plurality of pieces of reference information; and
generation control processing of causing the generation model to refer to the reference information extracted in the extraction processing and generate output data associated with the reference information and the target data.

10. A non-transitory computer-readable medium storing an information processing program for causing a computer to execute:
reception processing of receiving an input of target data as input data to a generation model subjected to machine learning to generate output data associated with input data;
extraction processing of extracting reference information, from a plurality of pieces of reference information the generation model can be caused to refer to, based on a label that indicates an attribute of each piece of reference information associated in advance with each of the plurality of pieces of reference information; and
generation control processing of causing the generation model to refer to the reference information extracted in the extraction processing and generate output data associated with the reference information and the target data.
